(19) United States
(12) Patent Application Publication
(10) Pub. No.: US 2013/0074268 A1
(43) Pub. Date: Mar. 28, 2013

(54) STRUCTURAL PNEUMATIC ACCUMULATOR SYSTEM

(71) Applicants: Timothy Joseph Receveur, Guilford, IN (US); Christopher R. O'Keefe, Batesville, IN (US); Eric R. Meyer, Greensburg, IN (US); Jason Brennan Grace, Cincinnati, OH (US)

(72) Inventors: Timothy Joseph Receveur, Guilford, IN (US); Christopher R. O'Keefe, Batesville, IN (US); Eric R. Meyer, Greensburg, IN (US); Jason Brennan Grace, Cincinnati, OH (US)

(21) Appl. No.: 13/242,199

(22) Filed: Sep. 23, 2011

(51) Int. Cl. A61G 7/05; A47C 19/02; F15D 1/00; A47C 27/08

(52) U.S. Cl. 5/630; 5/286; 137/565.17

(57) ABSTRACT

A pneumatic accumulator integral to a structural member of a person-support apparatus to store air is disclosed. The accumulator serves as a reservoir available for rapid changes in demand for pressurized air, for use by a variety of devices integral or external to the person-support apparatus or for extension and retraction of at least one portion of the person-support apparatus. A pump supplies air to the accumulator. The pump and at least one pressure sensor are in communication with a controller. At least one valve in the fluidic path is in communication with the controller and meters the supply of air. The controller may further be connected with an alarming unit, hospital network, activity log, communication station nurse call system or electronic medical records.

### BACKGROUND

Person-support apparatuses commonly found in hospital, extended care or home environments have at least one, and often several pneumatic devices for a variety of functionalities. Some of the common uses of pressurized air are for sequential compression therapy for prevention of Deep Vein Thrombosis (DVT), use in heating and cooling devices for providing physiotherapy and for continuous high frequency oscillation devices for chest compression. In such cases, a need to provide for an accumulator to account for rapid changes in the requirement of air is felt. Furthermore, in patient care environments, a need is felt to reduce the number of external devices attached to the person-support apparatus for a multitude of reasons, not least among which are ease of transportation of the person-support apparatus and enhancement of the patient environment.

### BRIEF SUMMARY

The present disclosure includes one or more of the features recited in the appended claims and/or the following features which, alone or in any combination, may comprise patentable subject matter.

In one embodiment of the structural pneumatic accumulator system, an accumulator is integral to at least one structural member of a person-support apparatus, the accumulator configured to store air. A pump is fluidly connected to the accumulator to provide a supply of air to the accumulator. In one embodiment, the pump may be configured to mount to the person-support apparatus external to the accumulator. In another embodiment, the pump may be configured to mount in the storage space of the accumulator with a provision for a pump inlet port external to the accumulator. A controller is in communication with the pump and provides signals to control actuation. In one embodiment, the controller may be configured to mount to the person-support apparatus external to the accumulator. In another embodiment, the controller may be configured to mount in the storage space of the accumulator. A pneumatic line fluidly connects the accumulator with at least one bladder in one embodiment. The at least one bladder may be mounted integral to a person-support surface, a frame or any other apparatus integral to the person-support apparatus. The at least one bladder may be used with any external device in one embodiment of the claimed subject matter.

In one embodiment of the structural pneumatic accumulator system, an accumulator is integral to at least one structural member of a person-support apparatus, the accumulator configured to store air. A pump is fluidly connected to the accumulator to provide a supply of air to the accumulator. In one embodiment the pump may be configured to mount to the person-support apparatus external to the accumulator. In another embodiment, the pump may be configured to mount in the storage space of the accumulator with a provision for a pump inlet port external to the accumulator. A controller is in communication with the pump and provides signals to control actuation. In one embodiment the controller may be configured to mount to the person-support apparatus external to the accumulator. In another embodiment, the controller may be configured to mount in the storage space of the accumulator. A support member of the person support apparatus fluidly connects the accumulator with a manifold in one embodiment. The manifold may be mounted integral to a person-support surface, a frame or any other apparatus integral to the person-support apparatus. The manifold may be used with any external device in one embodiment of the claimed subject matter.

In one embodiment of the structural pneumatic accumulator system, an accumulator is integral to at least one structural member of a person-support apparatus, the accumulator configured to store air. A pump is fluidly connected to the accumulator to provide a supply of air to the accumulator. In one embodiment the pump may be configured to mount to the person-support apparatus external to the accumulator. In another embodiment, the pump may be configured to mount in the storage space of the accumulator with a provision for a pump inlet port external to the accumulator. A controller is in communication with the pump and provides signals to control actuation. In one embodiment the controller may be configured to mount to the person-support apparatus external to the accumulator. In another embodiment, the controller may be configured to mount in the storage space of the accumulator. A pneumatic line fluidly connects the accumulator with a manifold in one embodiment. The manifold may be mounted integral to a person-support surface, a frame or any other apparatus integral to the person-support apparatus. The manifold may be used with any external device in one embodiment of the claimed subject matter.

In another embodiment of the structural pneumatic accumulator system, an accumulator is integral to at least one structural member of a person-support apparatus, the accumulator configured to store a fluid. The accumulator is supplied fluid by an external fluid supply.

### BRIEF DESCRIPTION OF THE DRAWINGS

The accompanying drawings incorporated in and forming a part of the specification illustrate several aspects of the claimed subject matter and, together with the description, serve to explain the principles of the claimed subject matter. In the drawings:

FIG. 1 is a schematic view of a structural pneumatic accumulator system, constructed according to principles of the teachings herein;

FIG. 2 is a schematic view of another structural pneumatic accumulator system, constructed according to the teachings herein;

FIG. 3 is a schematic view of yet another structural pneumatic accumulator system, constructed according to the teachings herein.

### DETAILED DESCRIPTION

The embodiments of the claimed subject mater and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be briefly mentioned or omitted so as to not unnecessarily obscure the embodiments of the claimed subject matter described. The examples used herein are intended merely to facilitate an understanding of ways in which the claimed subject matter may be practiced and to further enable those of skill in the art to practice the embodiments of the claimed subject matter described herein. Accordingly, the examples and embodiments herein should not be construed as limiting the scope of the claimed subject matter, which is defined solely by the appended claims and applicable law. Moreover, it is noted that like reference numerals represent similar parts throughout the several views of the drawings.

It is understood that the subject matter claimed is not limited to the particular methodology, protocols, devices, apparatus, materials, applications, etc., described herein, as these may vary. It is also to be understood that the terminology used herein is used for the purpose of describing particular embodiments only, and is not intended to limit the scope of the claimed subject matter. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art.

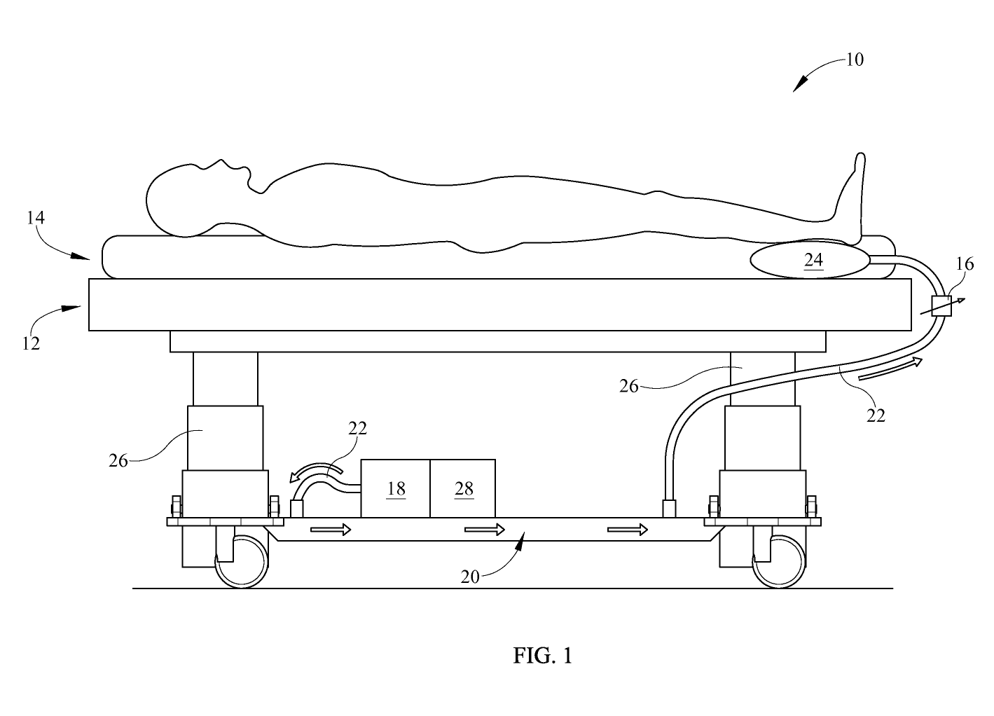

The embodiment of the structural pneumatic accumulator system as shown in FIG. 1 describes an accumulator 20 for use in a person-support apparatus 10. The accumulator 20 is a structural member of a person-support apparatus 10. In general, a structural member relates to any member of a person-support apparatus 10 which is in the load path or inherent to the design of the person-support apparatus 10, in case of a hospital bed, any section of the hospital bed frame, head board, foot board or side rail may serve as an accumulator 20. The accumulator 20 serves as a reservoir of air available to respond quickly to varying need. A pump 18 is configured to supply air to the accumulator 20. In one embodiment, the pump 18 may be mounted external to the accumulator on the person-support apparatus 10. In another embodiment, not shown in FIG. 1, the pump 18 may be mounted internal to the accumulator 20. In yet another embodiment, fluid could be supplied by an external fluid supply; in one embodiment fluid may be supplied to the accumulator from pressurized fluid lines in a hospital room. A controller 28 is in communication with the pump 18 and provides signals to control actuation. The controller 28 can be any programmable device capable of receiving at least one of analog or digital signals and providing control signals. In one embodiment, the controller 28 may be mounted external to the accumulator on the person-support apparatus 10. In another embodiment, not shown in FIG. 1, the controller 28 may be mounted internal to the accumulator 20. Although not shown in FIG. 1, one skilled in the art would appreciate that the accumulator may have internal partitions such that at least some of the electrical and electronic components are not exposed to the pressurized environment. In one embodiment, not shown in FIG. 1, the controller 28 may be in communication with a hospital network 36. One skilled in the art would appreciate that communication with the hospital network 36 maybe through a wired connection or a wireless connection. The pump 18 is fluidly connected to the accumulator 20 and supplies air to the accumulator 20. In one embodiment the pump 18 may be fluidly connected to the accumulator via a pneumatic line 22 as shown in FIG. 1. In another embodiment of the claimed subject matter, the pump 18 may be directly connected to the accumulator 20. Although not shown in FIG. 1, the accumulator may include a pressure relief valve or any other type of valve integral to its structure. In one embodiment, the accumulator 20 supplies fluid to a pneumatic actuator which actuates a frame member of the person-support apparatus. The pneumatic actuator may be of linear or rotary type and may actuate devices external to the person-support apparatus 20 in another embodiment. The accumulator 20 is fluidly connected to at least one bladder 24 via a pneumatic line 22 in yet another embodiment. As shown in FIG. 1, the at least one bladder 24 may be integral to a person-support surface 14. In another embodiment, although not shown in FIG. 1, the at least one bladder may be mounted on top of or external to the person-support surface 14. In yet another embodiment, the at least one bladder 24 may be integral to the frame 12 of the person-support apparatus. The accumulator 20 supplies air to the at least one bladder 24 which allows for extension or retraction of at least one section of the person-support apparatus 10 in one embodiment. In one configuration of the person-support apparatus 10, the accumulator 20 supports the frame 12 and the person-support surface 14 via at least one support member 26. In another embodiment, the accumulator may be integral to the frame 12 or the at least one support member 26. The at least one bladder 24 may be used for numerous purposes, including, but not limited to assisting the patient turn from side to side, providing sequential compression therapy, inflating or deflating person support surface 14, percussion and vibration therapy, heating and cooling of person-support surface 14 and humidity control of person-support surface 14. In yet another embodiment, the accumulator 20 supplies fluid to a pneumatic actuator to actuate a frame member of the person-support apparatus 10. In At least one valve 16 is in the fluidic path between the pump 18 and the bladder 24. As shown in FIG. 1, the at least one valve 16 may be connected serially in the pneumatic line 22. In another embodiment, the at least one valve 16 may be mounted to any one of the pump 18, accumulator 20 or bladder 24. In yet another embodiment, more than one valve 16 may be mounted to any one of the pump 18, accumulator 20, pneumatic line 22 and bladder 24 in any combination. Although not shown in FIG. 1, at least one pressure sensor 32 may be mounted to any one of the pump 18, accumulator 20, pneumatic line 22 and bladder 24. The pressure sensor 32 in communication with the controller 28.

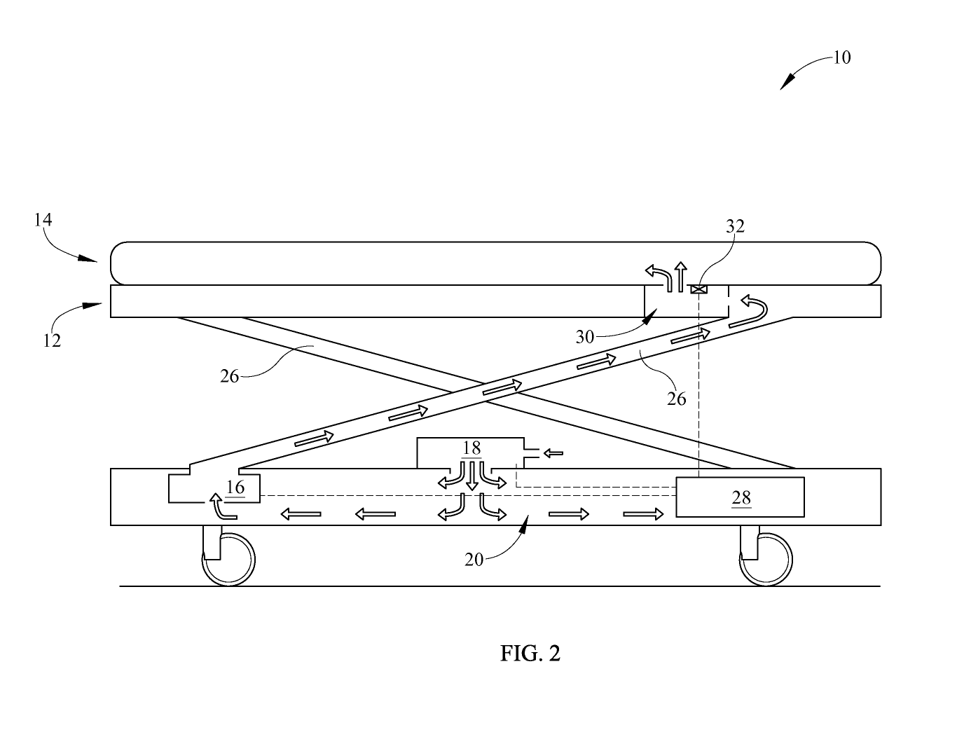

The embodiment of the structural pneumatic accumulator system as shown in FIG. 2 describes an accumulator 20 for use in a person-support apparatus 10. In one embodiment of the claimed subject matter, the accumulator 20 is a structural member of a person-support apparatus 10. A pump 18 is configured to supply air to the accumulator 20. The accumulator 20 serves as a reservoir of air available to respond quickly to varying need. In one embodiment, the pump 18 may be mounted external to the accumulator on the person-support apparatus 10. In another embodiment, not shown in FIG. 2, the pump 18 may be mounted internal to the accumulator 20. In yet another embodiment, fluid could be supplied by an external fluid supply; in one embodiment fluid may be supplied to the accumulator from pressurized fluid lines in a hospital room. A controller 28 is in communication with the pump 18 and provides signals to control actuation. The controller 28 can be any programmable device capable of receiving at least one of analog or digital signals and providing control signals. In one embodiment, the controller 28 may be mounted internal to the accumulator 20. Although not shown in FIG. 2, one skilled in the art would appreciate that the accumulator may have internal partitions such that at least some of the electrical and electronic components are not exposed to the pressurized environment. In another embodiment, not shown in FIG. 2, the controller 28 may be mounted external to the accumulator on the person-support apparatus 10. In one embodiment, not shown in FIG. 2, the controller 28 may be in communication with a hospital network 36. One skilled in the art would appreciate that communication with the hospital network 36 maybe through a wired connection or a wireless connection. The pump 18 is fluidly connected to the accumulator 20 and supplies air to the accumulator 20. In one embodiment the pump 18 may be fluidly connected to the accumulator via a pneumatic line 22. In another embodiment of the claimed subject matter, the pump 18 may be directly connected to the accumulator 20. Although not shown in FIG. 2, the accumulator 20 may include a pressure relief valve or any other type of valve integral to its structure. The accumulator 20 is fluidly connected to at least one manifold 30 via a support member 26 which acts as a fluid conduit. As shown in FIG. 2, the at least one manifold 30 may be integral to the frame 12. In another embodiment, although not shown in FIG. 2, the at least one manifold 30 may be mounted on top of or external to the person-support surface 14. In yet another embodiment, the at least one manifold 30 may be integral to the person-support surface 14. In one configuration of the person-support apparatus 10, the accumulator 20 supports the frame 12 and the person-support surface 14 via at least one support member 26. In another embodiment, the accumulator may be integral to the frame 12 or the at least one support member 26. In one embodiment, the at least one manifold 30 is a pipe member with a single inlet and a single outlet. In another embodiment, the manifold may have one inlet and more than one outlet. In yet another embodiment, the manifold may have multiple inlets and outlets. The at least one manifold 30 may be used for numerous purposes, including, but not limited to distributing air to systems which assist the patient turn from side to side, provide sequential compression therapy, percussion and vibration therapy, heating and cooling of person-support surface 14 and humidity control of person-support surface 14. In one embodiment, the accumulator 20 supplies fluid to a pneumatic actuator which actuates a frame member of the person-support apparatus. The pneumatic actuator may be of linear or rotary type and may actuate devices external to the person-support apparatus 20 in another embodiment. At least one valve 16 is in the fluidic path between the pump 18 and the bladder 24. As shown in FIG. 2, the at least one valve 16 may be integral to the accumulator 20. In another embodiment, the at least one valve 16 may be mounted to any one of the pump 18, support member 26 or manifold 30. In yet another embodiment, more than one valve 16 may be mounted to any one of the pump 18, accumulator 20, support member 26 and manifold 30 in any combination. As shown in FIG. 2, a pressure sensor 32 may be mounted to the manifold 30 in one embodiment. In another embodiment at least one pressure sensor 32 may be mounted to any one of the pump 18, accumulator 20, pneumatic line 22 and bladder 24. The pressure sensor 32 is in communication with the controller 28.

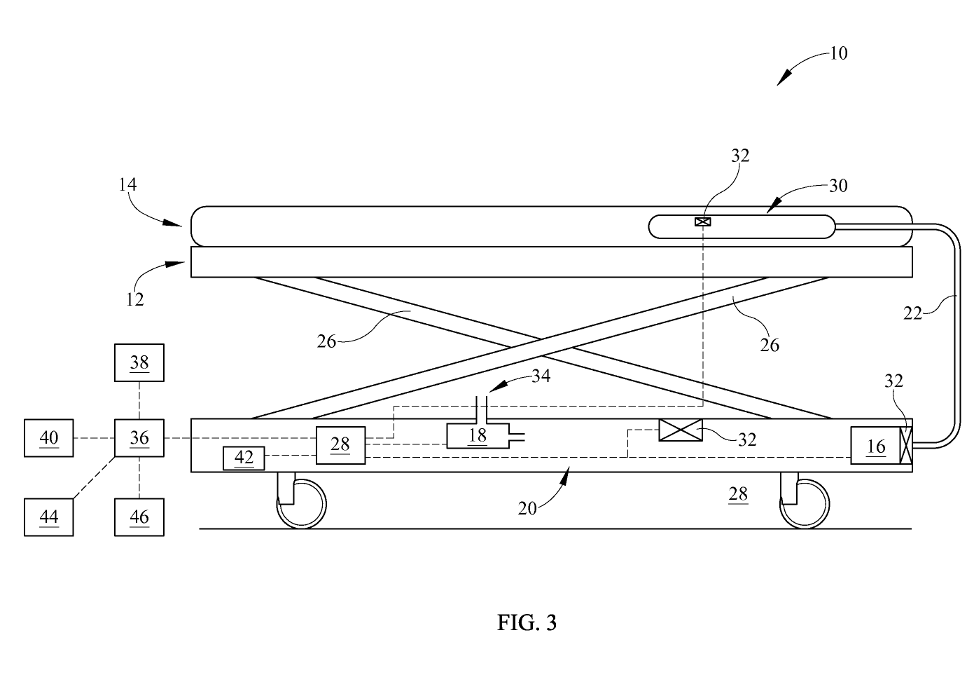

The embodiment of the structural pneumatic accumulator system as shown in FIG. 3 describes an accumulator 20 for use in a person-support apparatus 10. In one embodiment of the claimed subject matter, the accumulator 20 is a structural member of a person-support apparatus 10. A pump 18 is configured to supply air to the accumulator 20. The accumulator 20 serves as a reservoir of air available to respond quickly to varying need. In one embodiment, shown in FIG. 3, the pump 18 may be mounted internal to the accumulator 20. In another embodiment, the pump 18 may be mounted external to the accumulator on the person-support apparatus 10. In yet another embodiment, fluid could be supplied by an external fluid supply; in one embodiment fluid may be supplied to the accumulator from pressurized fluid lines in a hospital room. A controller 28 is in communication with the pump 18 and provides signals to control actuation. The controller 28 can be any programmable device capable of receiving at least one of analog or digital signals and providing control signals. In one embodiment, the controller 28 may be mounted internal to the accumulator 20. Although not shown in FIG. 3, one skilled in the art would appreciate that the accumulator may have internal partitions such that at least some of the electrical and electronic components are not exposed to the pressurized environment. In another embodiment, not shown in FIG. 3, the controller 28 may be mounted external to the accumulator on the person-support apparatus 10. In one embodiment, as shown in FIG. 3, the controller 28 may be in communication with a hospital network 36. One skilled in the art would appreciate that communication with the hospital network 36 maybe through a wired connection or a wireless connection and may be of type, including, but not limited to a telephone network, computer network, internet network, wide area network (WAN), local area network (WAN), virtual private network (VPN) and campus area network (CAN). The hospital network 36 may be further connected to a fixed or mobile communication station 40 where information may be centralized in one embodiment and a nurse call system 38 as shown in FIG. 3. The hospital network 36 may also be connected to electronic medical records 44 and an activity log 46 in one embodiment. In one embodiment, the activity log 46 stores information from sensors mounted on the patient-support apparatus, patient-support surface or any device external to the patient-support apparatus. In another embodiment, not shown in FIG. 3, the controller may directly be in communication with the electronic medical records 44 and activity log 46. The controller 28 may also be in communication with an alarming unit 42 as shown in FIG. 3. The alarming unit 42 provides at least one of an audio, visual or vibratory alarm when commanded to do so by the controller 28. In one embodiment, the controller 28 may activate the alarming unit 42 if for instance the pressure sensor 32 provides a signal outside a predetermined range. The pump 18 is fluidly connected to the accumulator 20 and provides air to the accumulator 20. In one embodiment the pump 18 may be fluidly connected to the accumulator via a pneumatic line 22. In another embodiment of the claimed subject matter, the pump 18 may be directly connected to the accumulator 20. Although not shown in FIG. 3, the accumulator 20 may include a pressure relief valve or any other type of valve integral to its structure. The accumulator 20 is fluidly connected to at least one manifold 30 via a pneumatic line 22, which acts as a fluid conduit. In another embodiment not shown in FIG. 3, a support member 26 may serve as the fluid conduit between the accumulator 20 and the manifold 30. In one embodiment, the accumulator 20 supplies fluid to a pneumatic actuator which actuates a frame member of the person-support apparatus. The pneumatic actuator may be of linear or rotary type and may actuate devices external to the person-support apparatus 20 in another embodiment. As shown in FIG. 3, the at least one manifold 30 may be integral to a person-support surface 14. In another embodiment, although not shown in FIG. 3, the at least one manifold 30 may be mounted on top of or external to the person-support surface 14. In yet another embodiment, the at least one manifold 30 may be integral to the frame 12. In one configuration of the person-support apparatus 10, the accumulator 20 supports the frame 12 and the person-support surface 14 via at least one support member 26. In another embodiment, the accumulator may be integral to the frame 12 or the at least one support member 26. The at least one manifold 30 may be used for numerous purposes, including, but not limited to distributing air to systems which assist the patient turn from side to side, provide sequential compression therapy, percussion and vibration therapy, inflating or deflating person support surface 14, heating and cooling of person-support surface 14 and humidity control of person-support surface 14. At least one valve 16 is in the fluidic path between the pump 18 and the bladder 24. As shown in FIG. 3, the at least one valve 16 may be integral to the accumulator 20. In another embodiment, the at least one valve 16 may be mounted to any one of the pump 18, support member 26 or manifold 30. In yet another embodiment, more than one valve 16 may be mounted to any one of the pump 18, accumulator 20, support member 26 and manifold 30 in any combination. As shown in FIG. 3, a pressure sensor 32 may be mounted to the manifold 30 in one embodiment. In another embodiment at least one pressure sensor 32 may be mounted to any one of the pump 18, accumulator 20, pneumatic line 22 and bladder 24. The pressure sensor 32 is in communication with the controller 28.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

The disclosures of any references and publications cited above are expressly incorporated by reference in their entireties to the same extent as if each were incorporated by reference individually.

We claim:

1. A structural pneumatic accumulator system for use in a person-support structure, comprising:
an accumulator, said accumulator a structural member of said person-support structure;
a pump fluidly connected to said accumulator;
a controller in communication with said pump.

2. The structural pneumatic accumulator system of claim 1, further comprising at least one pneumatic line fluidly connected with said accumulator.

3. The structural pneumatic accumulator system of claim 2, further comprising at least one bladder fluidly connected with said pneumatic line.

4. The structural pneumatic accumulator system of claim 3, further comprising at least one valve in communication with said controller, said valve in the fluidic path between said pump and said bladder.

5. The structural pneumatic accumulator system of claim 3, further comprising at least one pressure sensor coupled with at least one of said accumulator, said bladder and said pneumatic line.

6. The structural pneumatic accumulator system of claim 5, said at least one pressure sensor in communication with said controller.

7. The structural pneumatic accumulator system of claim 1, said controller in communication with a hospital network.

8. The structural pneumatic accumulator system of claim 1, said controller in communication with an alarming unit.

9. The structural pneumatic accumulator system of claim 1, further comprising an activity log in communication with said controller.

10. The structural pneumatic accumulator system of claim 1, further comprising a pneumatic actuator, said pneumatic actuator supplied fluid by said accumulator and configured to actuate said person-support apparatus.

11. A structural pneumatic accumulator system for use in a person-support structure, comprising:
an accumulator, said accumulator a first structural member of said person-support structure;
a pump fluidly connected to said accumulator;
a controller in communication with said pump;
a manifold;
a support member, said support member a second structural member of said person-support structure, said support member in fluidic communication with said accumulator and said manifold.

12. The structural pneumatic accumulator system of claim 11, further comprising at least one valve in communication with said controller, said valve in the fluidic path between said pump and said manifold.

13. The structural pneumatic accumulator system of claim 11, further comprising at least one pressure sensor coupled with at least one of said accumulator, said manifold and said support member.

14. The structural pneumatic accumulator system of claim 13, said at least one pressure sensor in communication with said controller.

15. The structural pneumatic accumulator system of claim 11, said controller in communication with a hospital network.

16. The structural pneumatic accumulator system of claim 11, said controller in communication with an alarming unit.

17. The structural pneumatic accumulator system of claim 11, further comprising an activity log in communication with said controller.

18. A structural pneumatic accumulator system for use in a person-support structure, comprising:
an accumulator, said accumulator a structural member of said person-support structure;
a pump fluidly connected to said accumulator;
a controller in communication with said pump;
a manifold;
a pneumatic line, said pneumatic line in fluidic communication with said accumulator and said manifold.

19. The structural pneumatic accumulator system of claim 18, further comprising at least one valve in communication with said controller, said valve in the fluidic path between said pump and said manifold.

20. The structural pneumatic accumulator system of claim 18, further comprising at least one pressure sensor coupled to at least one of said accumulator, said manifold and said pneumatic line.

21. The structural pneumatic accumulator system of claim 18, said at least one pressure sensor in communication with said controller.

22. A structural pneumatic accumulator system for use in a person-support structure, comprising:
an accumulator, said accumulator a structural member of said person-support structure, said accumulator supplied fluid by an external fluid source.
